(19) United States
(12) Patent Application Publication
(10) Pub. No.: US 2007/0274239 A1
(43) Pub. Date: Nov. 29, 2007

(54) System and method for automatic detection of network port configuration mismatch

(75) Inventors: Cuong T. Nguyen, Austin, TX (US); Joseph D. DeNiro, Austin, TX (US); Joseph Burton Farrell, Austin, TX (US); Bruce A. Holmes, Austin, TX (US); Mohana R. Mullapudi, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/441,868

(22) Filed: May 26, 2006

(51) Int. Cl. H04B 1/44

(52) U.S. Cl. 370/282

(57) ABSTRACT

A method for automatically detecting a port configuration mismatch between a switch and its peer switch comprises listening, by the switch, to its peer switch's advertisement of its duplex setting, generating a warning notification in response to the peer switch advertising as capable of only operating at half duplex and the switch being set to an auto-negotiate setting, and transmitting the warning notification to a user.

### BACKGROUND

The present disclosure relates generally to information handling systems, and more particularly to automatic detection of network port configuration mismatch.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs are often interconnected by computer networks such as the Ethernet. Typically the computer network ports at two ends of a computer network link can automatically detect, negotiate and configure their respective speed and duplex settings—a process commonly called auto-negotiation. However, certain users prefer to manually set the port configuration parameters or some equipment are incapable of auto-negotiation. As a result, the network link may fail due to a mismatch in network port configuration settings and the communications between the IHSs would no longer be possible. Because the timing and manner in which the network error may occur are variable and may be attributable to a number of reasons, the failure and its cause is often difficult to diagnose quickly.

Prior proposed solutions to this problem required enhancements or modifications to the network signaling protocols. Because changes to signaling protocols are difficult to institute and promulgate, this solution is not practicable.

Accordingly, it would be desirable to provide for automatic detection of network port configuration mismatch absent the disadvantages found in the prior methods discussed above.

### SUMMARY

According to one embodiment, a method for automatically detecting a port configuration mismatch between a switch and its peer switch comprises listening, by the switch, to its peer switch's advertisement of its duplex setting, generating a warning notification in response to the peer switch advertising as capable of only operating at half duplex and the switch being set to an auto-negotiate setting, and transmitting the warning notification to a user.

According to another embodiment, a network switch comprises a microprocessor, a system memory coupled to the microprocessor, means for listening, by the switch, to its peer switch's advertisement of its duplex setting, means for generating a warning notification in response to the peer switch advertising as capable of only operating at half duplex and the switch being set to an auto-negotiate setting, and means for transmitting the warning notification to a user.

According to another embodiment, a computer network having at least a switch and its peer switch coupled by a network link comprises means for listening, by the switch, to its peer switch's advertisement of its duplex setting, means for generating a warning notification in response to the peer switch advertising as capable of only operating at half duplex and the switch being set to an auto-negotiate setting, means for generating a warning notification in response to the peer switch advertising as capable of only operating at half duplex and the switch not being set to a fixed half duplex setting, means for generating a warning notification in response to the peer switch advertising as capable of operating at both half and full duplex settings and the switch being set to a fixed half duplex setting, and means for transmitting the warning notification to a user.

According to another embodiment, a computer-readable medium having encoded thereon a method of detecting a network port configuration mismatch condition wherein the method comprises listening, by the switch, to its peer switch's advertisement of its duplex setting, generating a warning notification in response to the peer switch advertising as capable of only operating at half duplex and the switch being set to an auto-negotiate setting, generating a warning notification in response to the peer switch advertising as capable of only operating at half duplex and the switch not being set to a fixed half duplex setting, generating a warning notification in response to the peer switch advertising as capable of operating at both half and full duplex settings and the switch being set to a fixed half duplex setting, and transmitting the warning notification to a user.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified top level block diagram of an embodiment of an IHS.

FIG. 2 is a simplified block diagram showing two IHSs coupled by a computer network.

FIG. 3 is a flowchart of an embodiment of a method for automatic detection of network port configuration mismatch.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

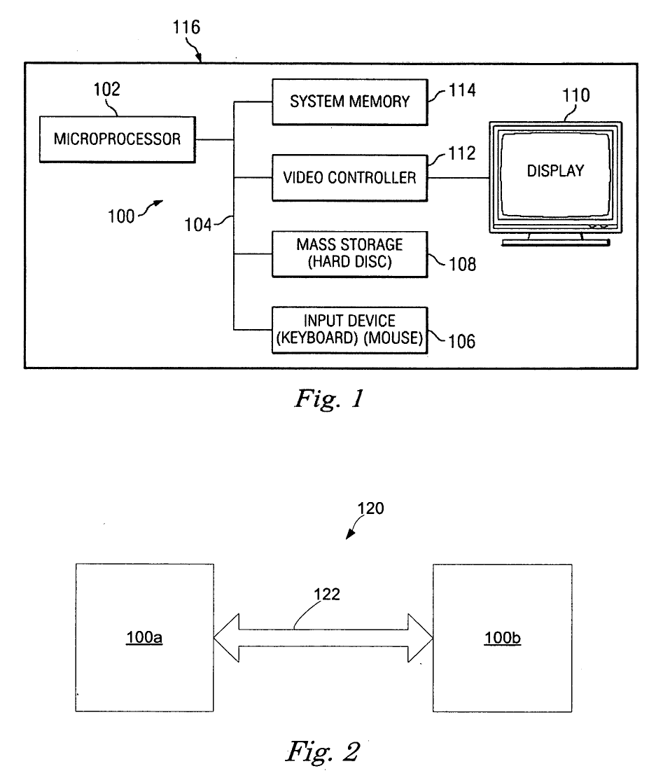

In one embodiment, IHS 100, FIG. 1, includes a microprocessor 102, which is connected to a bus 104. Bus 104 serves as a connection between microprocessor 102 and other components of computer system 100. An input device 106 is coupled to microprocessor 102 to provide input to microprocessor 102. Examples of input devices include keyboards, touchscreens, and pointing devices such as mouses, trackballs and trackpads. Programs and data are stored on a mass storage device 108, which is coupled to microprocessor 102. Mass storage devices include such devices as hard disks, optical disks, magneto-optical drives, floppy drives and the like. IHS system 100 further includes a display 110, which is coupled to microprocessor 102 by a video controller 112. A system memory 114 is coupled to microprocessor 102 to provide the microprocessor with fast storage to facilitate execution of computer programs by microprocessor 102. In an embodiment, a chassis 116 houses some or all of the components of IHS 100. It should be understood that other buses and intermediate circuits can be deployed between the components described above and microprocessor 102 to facilitate interconnection between the components and the microprocessor.

FIG. 2 is a simplified block diagram showing two IHSs 100a and 100b coupled by a computer network 122 such as a local area network (LAN) and other suitable networks. In this example, IHSs 100a and 100b may be network switches or other equipment coupled to two ends of a network link. It is essential that both the network port and the IHS connected to it use the same speed and duplex settings. Auto-negotiation was a solution that was introduced to ensure that the port configurations matched. When a network switch is configured to perform auto-negotiation, it will advertise its capabilities to allow its peer to negotiate to a common usable set of configuration parameters. Although auto-negotiation worked correctly in many applications, network errors were still occurring because many users continued to force the configuration of these parameters on the network port which resulted in configuration mismatch. By industry standard, if a switch was configured as having a fixed configuration, it will advertise itself as operating at half-duplex no matter how it is actually configured. If the port with the fixed parameter advertises itself as being half-duplex, then the auto-negotiate side will be set to half-duplex to match the port with the fixed configuration, even though it may actually be configured as operating at full duplex. Accordingly, a solution is proposed herein that addresses this problem. A system and method 120 are described herein operable to automatically detect network port configuration mismatch so that the user is alerted and can take corrective steps. System and method 120 are effective even if they are deployed at only one IHS at one end of the computer network link and do not require any network signaling protocol modifications

Assume that switch A (IHS 100a) has deployed the automatic detection and warning system and method described herein, and switch B is a peer switch that may or may not have implemented the automatic detection and warning system and method. There are two general scenarios—one in which switch A is set to auto-negotiate, and another in which switch A is set to a fixed speed and duplex configuration. In either scenarios, switch A is made to listen to its peer's advertisement of its speed and duplex capabilities.

In the first scenario, switch A is set to auto-negotiate. Switch A listens to switch B's advertisement and determines that switch B is advertising half duplex. If switch B is also set to auto-negotiate, then it is only capable of operating at half duplex. Since switch A is also set to auto-negotiate, then both switches will negotiate to operate at half duplex and there should not be any configuration mismatch problem. On the other hand, if switch B is actually operating in a fixed mode, then it may be advertising half duplex but is actually operating at full duplex per industry standard. In this instance, switch A would incorrectly negotiate to half duplex which would lead to a configuration mismatch problem. Because there is no practical way to determine whether switch B is set to auto-negotiate or fixed mode, the automatic detection system and method described herein always generate and convey a warning notification to the user if switch B is advertising as capable of operating only at half duplex.

In the second scenario, switch A is set to fixed mode. Again, switch A listens to switch B's advertisement and determines that switch B is advertising half duplex. If switch B is set to auto-negotiate, then it is only capable of operating at half duplex. In this case, switch A should generate and send a warning notification to the user only if its configured duplex does not match switch B's advertised duplex. On the other hand, if switch B is set to fixed mode then it may be advertising half duplex but is actually operating at full duplex per industry standard. In this instance, switch A should generate and send a warning notification only if its configured duplex does not match switch B's advertised duplex setting. In the second scenario, a warning notification should be generated and sent when the duplex setting fixed for switch A is different from what is advertised by the peer switch.

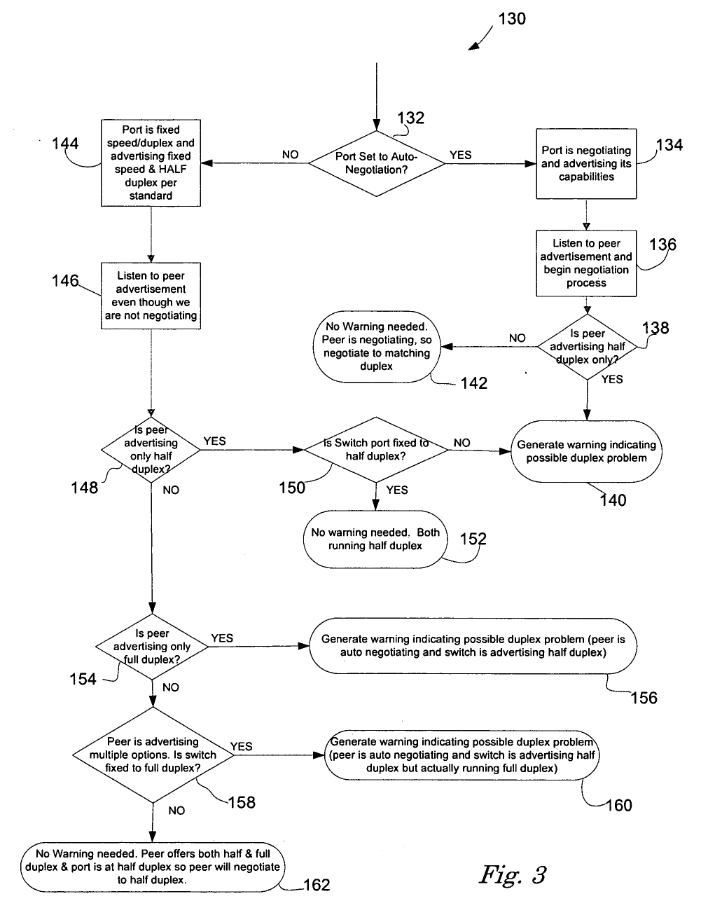

FIG. 3 is a flowchart of an embodiment of a method 130 for automatic detection of network port configuration mismatch. In block 132, a determination is made as to whether the port is set to auto-negotiate. If the port is set to auto-negotiate, then in block 134, the port proceeds to auto-negotiate and advertises its capabilities as part of the network configuration process. The port listens to its peer's advertisement begins the auto-negotiation process in block 136. A determination is then made in block 138 as to whether the peer is advertising as operating at half-duplex. If the peer is indeed advertising as operating at half-duplex, then in block 140 a warning is generated and conveyed to the user to indicate that a possible duplex mismatch problem may exist. The warning may be in the form of an email, page, or another form of notification that is effective in informing the user. Upon receipt of the warning, the user may decide to verify the port configuration settings on both ends of the link prior to any failure, or if a network error does develop, the user may look into duplex mismatch as a possible cause. If in block 138 a determination is made that the peer is not advertising as being capable of only operating at half-duplex, then no warning is needed because the peer is also set at auto-negotiate and both sides will auto-negotiate to reach the proper speed and duplex setting.

If, on the other hand, the port is not set to auto-negotiate as determined in block 132, then the port has a fixed speed and duplex setting. This port thus advertises that it is operating at half-duplex per industry standard in block 144. In step 146, the port listens to its peer's speed and duplex advertisement even though it is configured to a fixed speed and duplex setting. In block 148, a determination is made as to whether its peer is advertising as only capable of operating at half duplex. If the peer is advertising as operating at half duplex, then a determination is made as to its own duplex setting in block 150. If it is determined that its own duplex setting is fixed to half duplex, then no warning is needed to be given, as shown in block 152. No warning is necessary because both ports are operating at half duplex and there is no possibility of configuration mismatch. If in block 150 a determination is made that the port is not set to half duplex, then a warning is generated and conveyed in block 140 because there is a possibility of duplex mismatch. In this instance, the port has advertised itself as operating at half duplex yet it is not fixed to half duplex, its advertisement is thus not correct and may mislead the other port.

In block 148, if it is determined that the peer is not advertising as only capable of operating at half duplex, then a determination is made as to whether the peer is advertising that it is only capable of operating at full duplex in block 154. If so, then a warning is generated and conveyed to the user to indicate a possible duplex match problem in block 156. There is a possibility of duplex mismatch because the port is advertising as operating at half duplex but the peer is auto-negotiating and may end up configuring itself to half duplex, which may be incorrect. If in block 154 a determination is made that the peer is not advertising as only capable of operating at full duplex, then the peer is advertising multiple configuration options and a determination is made as to whether the port is fixed to operate at full duplex in block 158. If the port is fixed to operate at full duplex, then a warning is generated and conveyed to the user because there is a possibility of a duplex mismatch problem. In this instance, the peer is set to auto-negotiate but the port is advertising itself as operating at half duplex when it is actually operating at full duplex. If the port is not set to operate at full duplex, as determined in block 158, then no warning is needed because the peer is offering both half and full duplex configurations and the port is operating at half duplex. The result is that the peer will negotiate to operate at half duplex so there will not be a duplex mismatch problem.

Accordingly, the condition under which a warning about the possibility of duplex mismatch should be generated and conveyed to the user can be summarized in the following manner:
If ((the port setting is auto-negotiate AND the peer advertises half duplex) OR if (the port setting is fixed AND the peer advertises a mismatching duplex)) then warn the user of a possible duplex mismatch otherwise no warning is needed

In this embodiment, the switch implementing the method described above listens to the advertisement of its peer even when it is not set for auto-negotiation. By listening to its peer and comparing its own duplex configuration setting to how the peer may be configured, the conditions in which the possibility of duplex mismatch may occur becomes evident. In these instances, a warning is generated and sent to the user. The warning may be in the form of an email or another suitable form of notification that is effective in informing the user. Upon receipt of the warning, the user may decide to verify the port configuration settings on both ends of the link prior to the occurrence of any failure. Alternatively, if a network error does develop, the user may look into duplex mismatch as a possible cause.

The embodiments described herein are operable to automatically detect and warn about possible port configuration mismatch even if implemented at only one end of the link.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method for automatically detecting a port configuration mismatch between a switch and its peer switch, comprising:
listening, by the switch, to its peer switch's advertisement of its duplex setting;
generating a warning notification in response to the peer switch advertising as capable of only operating at half duplex and the switch being set to an auto-negotiate setting; and
transmitting the warning notification to a user.

2. The method of claim 1, further comprising generating a warning notification in response to the peer switch advertising as capable of only operating at half duplex and the switch not being set to a fixed half duplex setting.

3. The method of claim 1, further comprising generating a warning notification in response to the peer switch advertising as capable of operating at both half and full duplex settings and the switch being set to a fixed half duplex setting.

4. The method of claim 1, wherein transmitting the warning notification comprises transmitting an electronic mail to the user.

5. The method of claim 1, wherein transmitting the warning notification comprises paging the user.

6. The method of claim 1, wherein generating a warning notification comprises generating a message indicating that a network port configuration mismatch situation may be present.

7. A system for automatically detecting a port configuration mismatch between a first switch and a second switch, comprising:
means for listening, by the switch, to its peer switch's advertisement of its duplex setting;
means for generating a warning notification in response to the peer switch advertising as capable of only operating at half duplex and the switch being set to an auto-negotiate setting; and
means for transmitting the warning notification to a user.

8. The system of claim 7, further comprising means for generating a warning notification in response to the peer switch advertising as capable of only operating at half duplex and the switch not being set to a fixed half duplex setting.

9. The system of claim 7, further comprising means for generating a warning notification in response to the peer switch advertising as capable of operating at both half and full duplex settings and the switch being set to a fixed half duplex setting.

10. The system of claim 7, wherein means for transmitting the warning notification comprises means for transmitting an electronic mail to the user.

11. The system of claim 7, wherein means for transmitting the warning notification comprises means for paging the user.

12. The system of claim 7, wherein means for generating a warning notification comprises means for generating a message indicating that a network port configuration mismatch situation may be present.

13. A network switch comprising:
a microprocessor;
a system memory coupled to the microprocessor;
means for listening, by the switch, to its peer switch's advertisement of its duplex setting;
means for generating a warning notification in response to the peer switch advertising as capable of only operating at half duplex and the switch being set to an auto-negotiate setting; and
means for transmitting the warning notification to a user.

14. The switch of claim 13, further comprising:
means for generating a warning notification in response to the peer switch advertising as capable of only operating at half duplex and the switch not being set to a fixed half duplex setting; and
means for generating a warning notification in response to the peer switch advertising as capable of operating at both half and full duplex settings and the switch being set to a fixed half duplex setting.

15. The switch of claim 13, wherein means for transmitting the warning notification comprises means for transmitting an electronic mail to the user.

16. The switch of claim 13, wherein means for transmitting the warning notification comprises means for paging the user.

17. The switch of claim 13, wherein means for generating a warning notification comprises means for generating a message indicating that a network port configuration mismatch situation may be present.

18. A computer network having at least a switch and its peer switch coupled by a network link, comprising:
means for listening, by the switch, to its peer switch's advertisement of its duplex setting;
means for generating a warning notification in response to the peer switch advertising as capable of only operating at half duplex and the switch being set to an auto-negotiate setting;
means for generating a warning notification in response to the peer switch advertising as capable of only operating at half duplex and the switch not being set to a fixed half duplex setting;
means for generating a warning notification in response to the peer switch advertising as capable of operating at both half and full duplex settings and the switch being set to a fixed half duplex setting; and
means for transmitting the warning notification to a user.

19. A computer-readable medium having encoded thereon a method of detecting a network port configuration mismatch condition, the method comprising:
listening, by the switch, to its peer switch's advertisement of its duplex setting;
generating a warning notification in response to the peer switch advertising as capable of only operating at half duplex and the switch being set to an auto-negotiate setting;
generating a warning notification in response to the peer switch advertising as capable of only operating at half duplex and the switch not being set to a fixed half duplex setting;
generating a warning notification in response to the peer switch advertising as capable of operating at both half and full duplex settings and the switch being set to a fixed half duplex setting; and
transmitting the warning notification to a user.
